(19) United States
(12) Patent Application Publication
(10) Pub. No.: US 2009/0190332 A1
(43) Pub. Date: Jul. 30, 2009

(54) FLASHLIGHT HAVING BACK LIGHT ELEMENTS

(76) Inventor: Raymond L. Sharrah, Collegeville, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/356,364

(22) Filed: Jan. 20, 2009

Related U.S. Application Data
(63) Continuation-in-part of application No. 11/423,644, filed on Jun. 12, 2006, now Pat. No. 7,481,551.
Application No. 11/423,644 is a continuation-in-part of application No. 10/703,993, filed on Nov. 7, 2003, now Pat. No. 7,059,744.

(51) Int. Cl. F21V 21/084

(52) U.S. Cl. 362/105

(57) ABSTRACT

A flashlight for mounting on a helmet is provided. The flashlight includes a mount that is configured to be readily attachable to the brim of a variety of helmets. The flashlight includes a forward facing light to provide illumination and a rearward facing light for identifying the user.

### PRIORITY

This application is a Continuation-In-Part of U.S. patent application Ser. No. 11/423,644, filed Jun. 12, 2006, which is set to issue on Jan. 27, 2009 as U.S. Pat. No. 7,481,551, which is a Continuation-In-Part of U.S. patent application Ser. No. 10/703,993, filed Nov. 7, 2003, issued on Jun. 13, 2006 as U.S. Pat. No. 7,059,744. The entire disclosure of each of the foregoing references is hereby incorporated herein by reference.

### FIELD OF THE INVENTION

The present invention relates to portable lights, such as battery-powered flashlights. More specifically, the present invention relates to a flashlight having a primary light source providing forward facing light and a secondary light source providing rearward facing light. The present invention also relates to the field of portable lights to be mounted on the user's head. In particular, the present invention relates to a portable light configured to be mounted onto a helmet.

### BACKGROUND

Flashlights are used in a variety of fields and a variety of applications. In certain applications, such as, low light, obstructed view light applications, it is difficult to see the operator from behind, since the beam of light from the flashlight is shining forwardly. For instance, in emergency applications, such as in firefighting applications, emergency personnel using a flashlight shining forwardly may not be easily seen due to difficulties or obstructions arising from the fire and smoke. In such applications, it is important to be able to quickly locate and identify the emergency personnel. Furthermore, flashlights used in emergency applications should be configured to withstand adverse conditions and significant abuse that arises when responding to emergency situations.

A headlamp is a portable light that allows the user to illuminate an area without the need to hold the light. Since the light is mounted on the user's head, the user is free to use his or her hands for the task at hand. One common type of headlamp is a portable light having one or more straps for mounting the light on the user's head.

One particular field that a headlamp could be particularly useful is the field of emergency services, including firefighters and rescue personnel. However, emergency personnel wear safety helmets that often make the use of a strap mounted light difficult or impractical. Further still, the helmets used by emergency personnel vary significantly in shape and size. Additionally, safety codes preclude connections that would alter the physical characteristics of a helmet. For instance, a mounting element that would require a hole to be drilled into the helmet could require recertification for each helmet onto which the flashlight would be mounted. Obviously, it would be cost prohibitive to perform such re-certification for all of the various different helmets used by emergency personnel.

Many solutions have been proposed for mounting a flashlight onto helmets, however, the known solutions suffer from one or more substantial drawbacks. For instance, some of the known mounting elements are operable with some known helmets, but are limited to a few basic helmet designs. Other mounting elements are complicated and do not rigidly mount the light in a fixed orientation. Other lights fix the orientation of the light, but do not allow the beam to be adjusted for a particular helmet and/or user. Additionally, the known mounting elements are add-on units that are connected to the helmet by the user, and then connected to the light.

### SUMMARY OF THE INVENTION

Accordingly, there is a long-felt need for a flashlight with an integrated mounting element for mounting a flashlight onto a helmet in such a way that substantially rigidly fixes the orientation of the light beam while allowing the user to re-orient the light beam as necessary for the particular helmet. Therefore, the present invention provides a flashlight having a housing with a mounting element connected with the housing. The mounting element is configured to releasably connect the light onto the brim of a helmet. To allow the light to be attached to a variety of brims, the mounting element includes a lock that is variable between an upper limit and a lower limit for locking onto the brim. Additionally, the light may include an adjustment element for adjusting the angle of the light relative to the brim. According to one aspect, the mount is connected with the housing so that a drag force is created between the housing and the mount, which impedes rotation of the mount relative to the housing.

### DESCRIPTION OF THE DRAWINGS

The foregoing summary and the following detailed description will be better understood when read in conjunction with the drawings, in which:

FIG. 1 is a side elevational view of a flashlight;

FIG. 2 is an exploded perspective view of the flashlight illustrated in FIG. 1;

FIG. 2A is a perspective view of a portion of the flashlight illustrated in FIG. 1;

FIG. 3 is a rear elevational view of the flashlight illustrated in FIG. 1;

FIG. 4 is a plan view, partially in section of the flashlight illustrated in FIG. 3, taken along the line 4-4;

FIG. 5 is an enlarged fragmentary sectional view of the portion of the flashlight in FIG. 4 identified by Detail A;

FIG. 6 is a side elevational view of an alternative embodiment of a flashlight;

FIG. 7 is a perspective view of a second alternate embodiment of a flashlight;

FIG. 8 is a sectional view of the flashlight illustrated in FIG. 7; and

FIG. 9 is an enlarged fragmentary view partially broken away of the flashlight illustrated in FIG. 7.

FIG. 10 is a perspective view of a helmet light mounted onto a helmet above the brim of the helmet;

FIG. 11 is a perspective view of the helmet light of FIG. 10 mounted onto a helmet below the brim of the helmet;

FIG. 12 is a perspective view of the helmet light of FIG. 10;

FIG. 13a is a rearward view of the helmet light of FIG. 10;

FIG. 13b is a rearward view of the helmet light of FIG. 13a, with a mount reversed into a second orientation;

FIG. 14 is a sectional view of the helmet light of FIG. 13a, taken along line 5-5;

FIG. 15 is a sectional view of the helmet light of FIG. 14 taken along FIG. 6-6;

FIG. 16a is a perspective view of the helmet light of FIG. 10;

FIG. 16b is a perspective view of the helmet light of FIG. 16a, with the mount reversed into the second orientation;

### DETAILED DESCRIPTION OF THE PREFERRED EMBODIMENTS

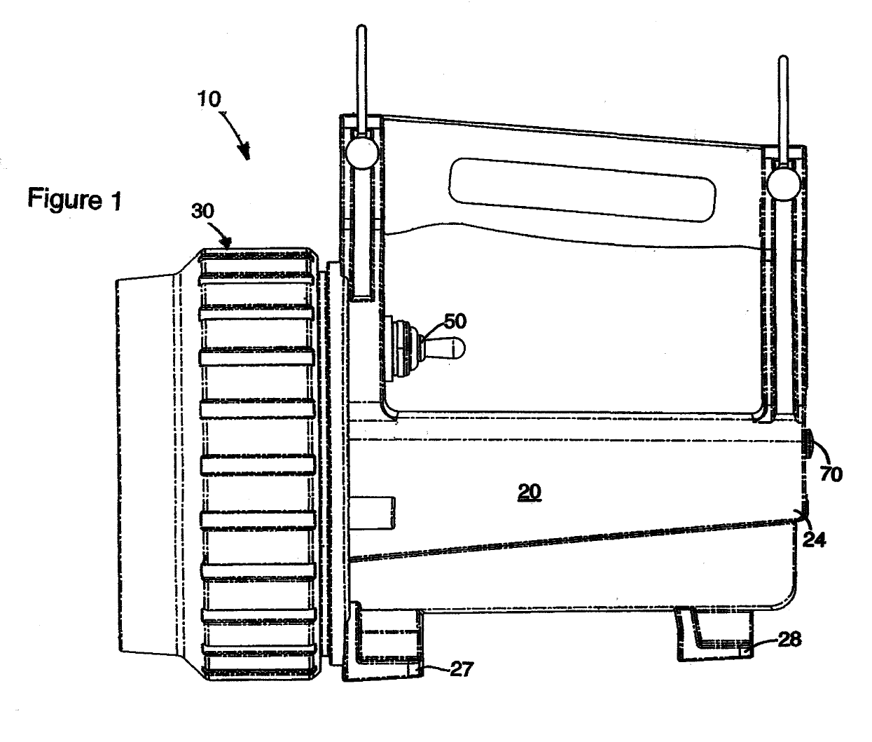

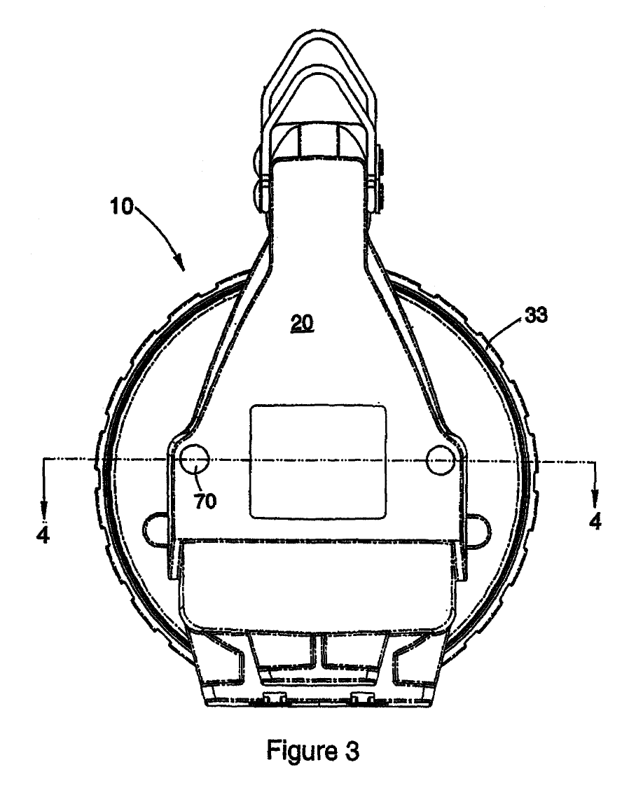

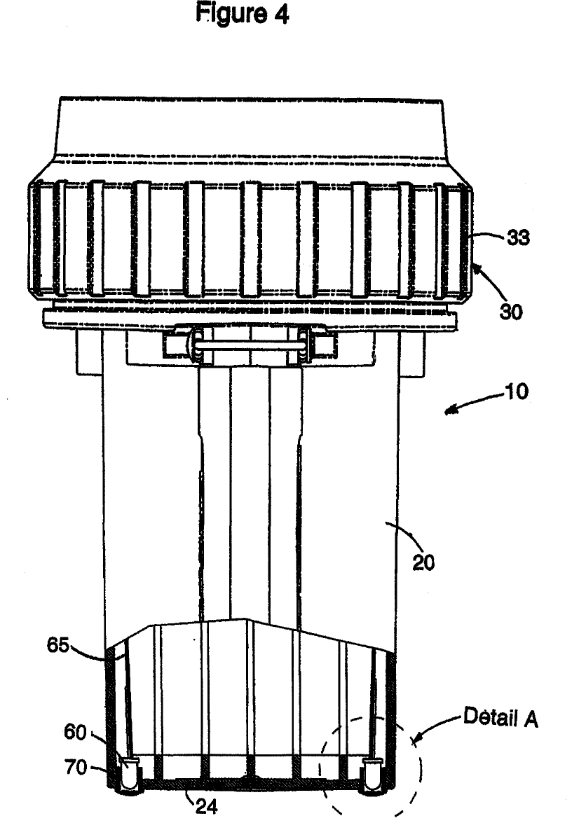

Referring now to the drawings in general and to FIGS. 1 and 3 specifically, a flashlight is designated generally 10. The flashlight 10 includes a lamp assembly 30 providing a forwardly directed light source, and one or more back lights 60 providing a rearwardly directed light source. The lamp assembly 30 includes a high-powered light to provide general illumination, whereas preferably the back light provides low power light so that the person using the flashlight can be readily identified from behind when using the flashlight.

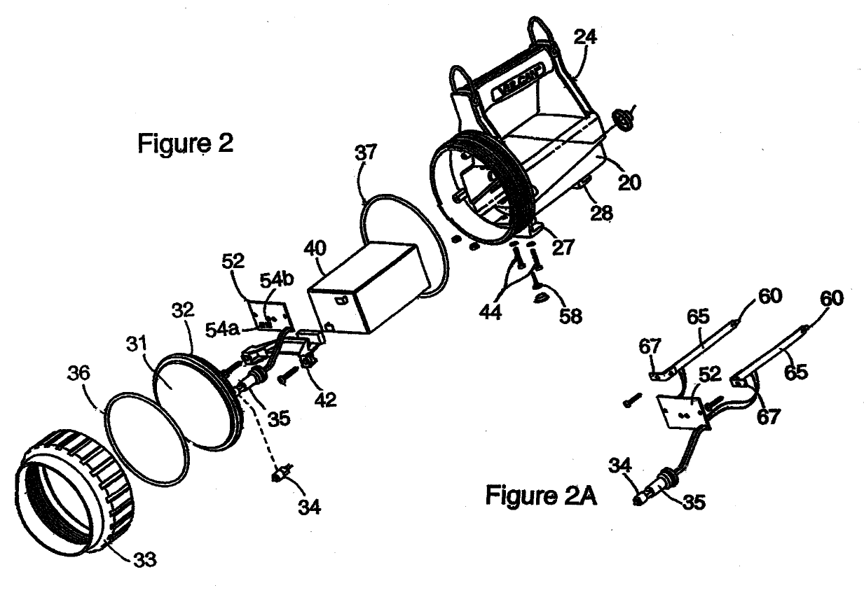

Referring now to FIG. 2, an exploded view illustrates most of the elements of the flashlight 10. The flashlight includes a hollow housing 20 having a generally open forward end and a generally closed rearward end. Although the housing 20 may be formed from a variety of material, including various metals and/or plastics, preferably, the housing is formed of high impact ABS.

The forward end of the housing 20 has an externally threaded portion that cooperates with the lamp assembly 30 to attach the lamp assembly to the housing. The lamp assembly 30 preferably includes a lens ring 33, a reflector 32, a lens 31 and a light bulb 34. In the present instance, preferably the lens 31 and the reflector 32 are fixedly connected to one another to form a lens/reflector assembly. However, a separate lens and reflector can also be utilized with the flashlight if desired.

The reflector includes a central aperture for receiving the light bulb 34. More specifically, preferably the light bulb 34 is mounted into a socket 35 and the socket extends into the central aperture of the reflector. In this way, the light bulb 34 projects inwardly into the reflector 32. Preferably, the light socket 35 comprises external threads and the opening in the reflector includes a threaded stem so that the light socket is threadedly connected to the reflector. The light bulb 34 is preferably a high intensity bulb, such as a bulb capable of providing up to 65,000 candlepower. For instance, the light bulb may be an 8 watt halogen bulb or a 6 watt xenon dual filament bulb. Alternatively, the light bulb may be a high intensity, ultra-bright LED.

The lens ring 33 is internally threaded to cooperate with the threaded portion on the front end of the housing 20. The light bulb 34 is connected to the light socket 35, which in turn is inserted into the opening in the reflector. The lens ring 33 is then placed over the lens/reflector and threaded onto the housing so that the reflector/lens is sandwiched between the lens ring and the housing. In addition, to provide a fluid-tight seal between the housing and the lamp assembly 30, preferably a pair of seals 36, 37, such as o-rings, are provided.

The housing includes a compartment configured to receive the battery 40. The battery may be a plurality of separate batteries or a single battery. In addition, the battery 40 may be rechargeable or non-rechargeable. In the present instance, preferably the battery is a 6-volt lead acid rechargeable battery. In addition, preferably a battery clamp 42 holds the battery in place in the housing. Preferably, the battery clamp 42 is similar to a safety bar that confronts the battery. The battery clamp 42 has a central portion formed to cooperate with the top surface of the battery 40, and the ends of the battery clamp have holes for securing the battery clamp. A pair of screws pass through the holes in the ends of the battery clamp and then into internally threaded recesses to screw the battery clamp to the housing.

If the battery is rechargeable, preferably the flashlight 10 includes a pair of charging terminals 44 that cooperate with a battery charger to recharge the battery while the battery remains in the housing. Preferably, the housing 20 comprises a front and back latch 27, 28 projecting from the bottom surface of the housing to cooperate with the charger. The latches operate to connect the flashlight to the charger to secure the flashlight in place on the charger during charging. Preferably, the charging terminals 44 are attached to the forward latch so that the charging terminal on the forward latch engages terminals on the charger to provide an electrical circuit between the charger and the battery. Since the flashlight is preferably fluid-tight, the flashlight preferably includes a valve allowing escape of gases created by the battery during use. The valve is a one-way valve, allowing gas to pass through the valve and out of the housing, while preventing fluid from entering the housing from outside the housing. In the present instance, the valve projects through a hole in the housing that extends through the front charger latch 27.

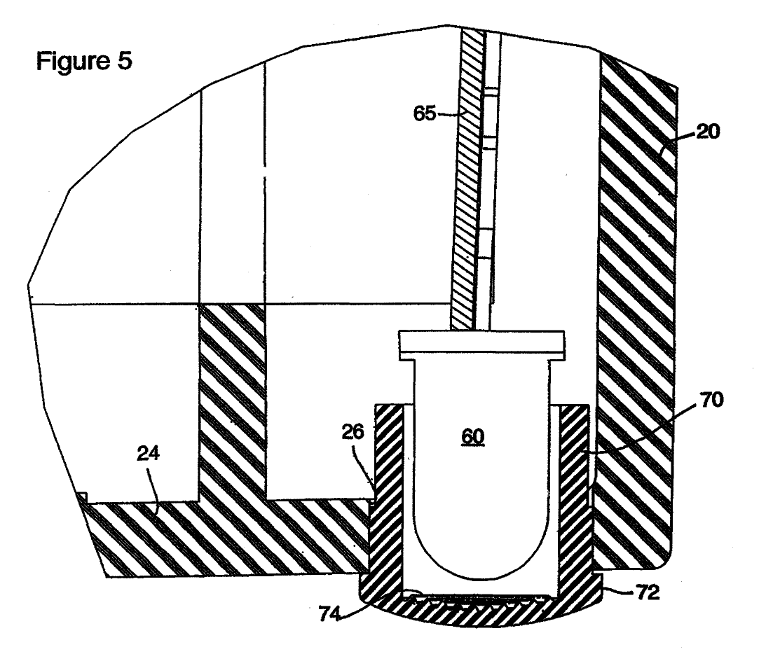

The rearward end of the housing 20 is generally closed by a back wall 24, which is substantially continuous except for a pair of apertures for the back lights 60. Referring to FIG. 5, the apertures 26 are preferably larger in diameter than the back lights 60 so that the lights can extend into the apertures. Each of the back lights 60 is covered by a cover 70 cover, which encloses each of the back lights 60.

As shown in FIG. 5, each cover 70 is a cup-shaped element. The rearward end of the cover 70 flares outwardly forming an enlarged head 72 having a diameter that is greater than the diameter of the aperture 26. The body portion of the cover 70 is generally cylindrical having an outer diameter that is configured to cooperate with the aperture.

The enlarged head 72 of the cover 70 forms a lens for the back light 60. Accordingly, the head of the cover is transparent or translucent. Depending on the type of light element used for the back light 60, it may be desirable to either focus the light or diffuse the light. However, in typical applications the back light is not primarily provided for illumination so it generally is not desirable to focus the light. Instead, in a typical application the light is used as a signal or locator, so it is desirable to diffuse the light. Accordingly, the cover 70 comprises a diffusion surface 74 for diffusing the light provided by the back lights 60. In applications in which it is desirable to focus the light provided by the back lights 60, a reflector may be provided to focus the rearwardly directed light.

The covers 70 are connected to the housing 20 to seal the apertures 26. In addition, preferably the covers are substantially permanently attached to the housing. Accordingly, the covers 70 may be inserted into the apertures 26 and bonded to the housing. Alternatively, the body portion of the cover may be slightly larger than the apertures to provide an interference fit between the cover and the aperture. In either way, since the head of the cover is preferably larger than the aperture, the head operates as a stop limiting the distance that the cover can be inserted into the aperture. Accordingly, the cover is inserted into the aperture 26 so that the enlarged head abuts the back wall so that the cover is generally flush with the back wall of the housing. Specifically, preferably the cover projects from the back wall a distance that is less than twice a thickness of the back wall, and more preferably a distance that is less than the thickness of the back wall.

Configured as described above, the back lights provide a rearward facing light source that does not project significantly from the back wall of the housing 20. In other words, the back light is substantially enclosed within the housing and the covers are substantially flush with the back wall.

As shown in FIG. 5, the back light 60 is preferably a two pin light element and the pins project into the housing 20. More specifically, preferably the back lights 60 are ultra-bright blue LEDs having two pins. The pins are fixedly connected to conductors 65 that extend between the battery and the back lights 60, as discussed further below.

Referring now to FIG. 1, the operation of the primary lamp 30 and the back lights 60 is controlled by a switch 50. The switch may be configured to have two or more switching positions. However, in the present instance the switch is a toggle switch having three positions, a central or off position, a left position and a right position.

Preferably, the switch 50 cooperates with a switch PCB 52 that controls the operation of the primary lamp and the back lights in conjunction with the switch. The switch PCB is interconnected with the battery 40, the primary lamp element 34, the back lights 60 and the switch 50. In the primary configuration of the switch PCB, the switch controls the flashlight as follows. When the switch is toggled into the left position, continuous power is provided to both the primary lamp 30 and the back lights 60 to provide continuous illumination by the light elements, referred to as a steady mode. When the switch is toggled to the right intermittent power is provided to both the primary lamp 30 and the back lights 60 so that the lights flash, referred to as flashing mode.

Preferably, the flashlight 10 allows the lighting modes to vary from the primary configuration described above. Specifically, preferably the switch PCB 52 comprises a plurality of contacts that are selectively interconnected by a plurality of removable conductive elements, such as jumpers 54a, 54b, as shown in FIG. 2. By removing one or both of the jumpers, the lighting modes are altered. Specifically, if the first jumper 54a is removed, the left switch position turns the primary lamp 30 on in steady mode, but does not turn on the back lights. The right switch position turns on both lights in flashing mode. If the second jumper is removed, the left switch position turns both lights on in steady mode. The right switch position turns on only the back lights in flashing mode. If both jumpers are removed the left position turns on just the primary lamp in steady mode. The rights switch position turns on just the back lights in flashing mode.

The electrical path between the switch PCB 52 and the primary lamp 30 is provided by a conductive cable that is connected to the light socket at one end and to the switch PCB at the other end. The back lights 60 may be similarly connected to the switch PCB. However, preferably, elongated back light PCBs 65 extend between the back lights and the switch PCB. Referring to FIG. 2A, the pins of each of the back lights 60 are soldered directly to one end of a back light PCB 65. A pair of conductive cables are connected to the second end of the PCB connector and also to the switch PCB 52 to complete the electrical path between the back lights and the switch PCB.

The back light PCBs 65 are preferably rigidly connected to the housing 20. Specifically, each of the back light PCBs have a mounting tab 67 fixedly attached to the second end, so that the mounting tab is separated from the electrical path. A fastener, such as a screw, attaches the mounting tab 67 to the housing. Accordingly, the back light PCBs 65 extend within the housing and are preferably spaced apart from the interior wall of the housing.

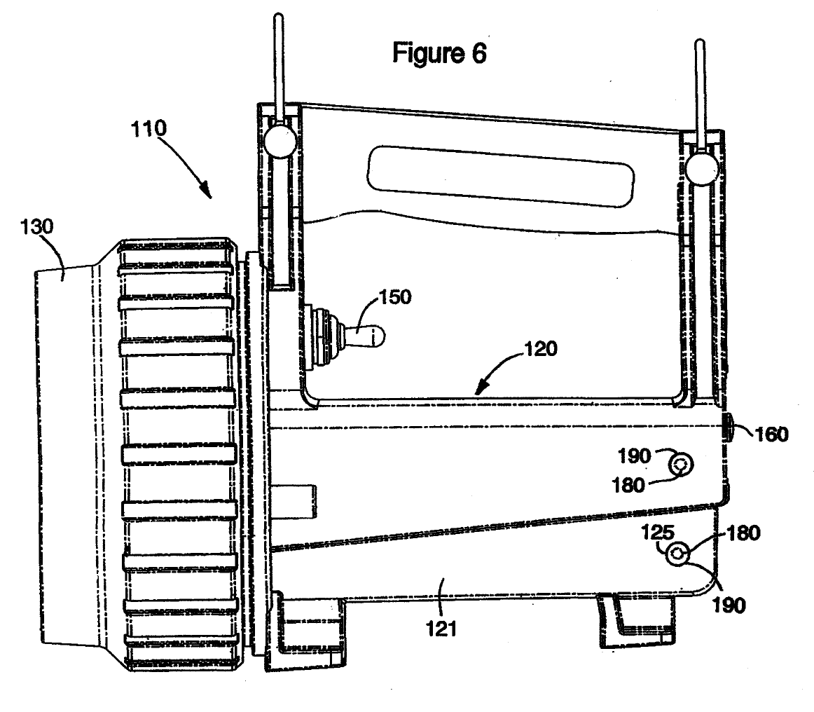

Referring now to FIG. 6 an alternate embodiment 110 is illustrated with an additional side light option. Elements in the alternative embodiment that are similar to elements in the first embodiment are identified with the same reference numbers with the addition of 100.

The flashlight 110 has a housing that has a front side 121 having apertures 125 for receiving LEDs 180. Preferably, the apertures 125 are configured similarly to the apertures 26 described previously in the first embodiment. In addition, preferably the LEDs 180 are enclosed within the housing 120 by covers 190 that are configured similarly to the covers 70 described above in the first embodiment. In this way, the side lights 180 are enclosed within the housing so that the side lights are substantially flush with the side 121 of the housing. In other words, at least a majority of the length, and preferably substantially the entire length, of the side LEDs 180 are disposed within the apertures 125 and the interior of the housing.

The side LEDs 180 may be provided as an alternative to the back light LEDs described in the first embodiment, so that the flashlight 110 has side lights and a primary lamp 130 similar to the lamp above, but no back lights. However, preferably, the flashlight has back lights 160 similar to the back lights 60 described above. In this way, the flashlight includes a forward light 130, back lights 160 projecting light rearwardly and side lights 180 disposed normal to the back lights and providing a light source directly sidewards from the housing. In addition, preferably the flashlight has side lights on the back side of the housing that are configured and arranged similarly to the sidelights described above. By providing the sidelights and the back lights, the flashlight can be readily seen from either the side or the back.

Preferably, the sidelights are controlled by a switch 150 similar to the switch 50 described above. Preferably the side lights are controlled together with the back lights so that when the back lights are switched on the sidelights are also switched on. However, the switching circuit can be configured to operate the side lights independently from the back lights if desired.

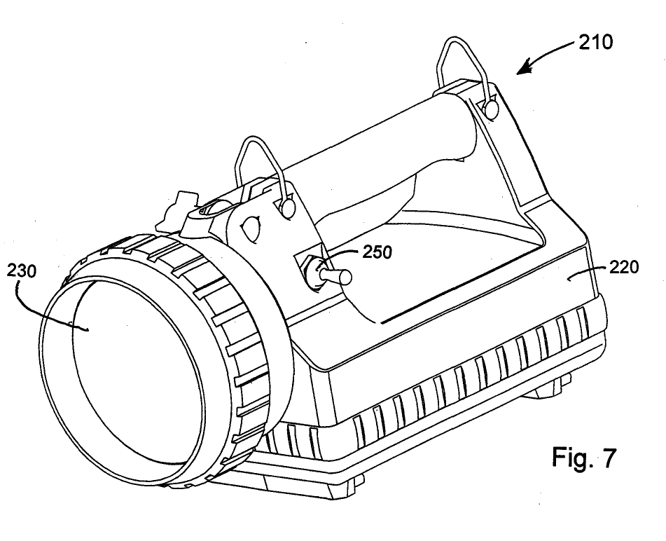

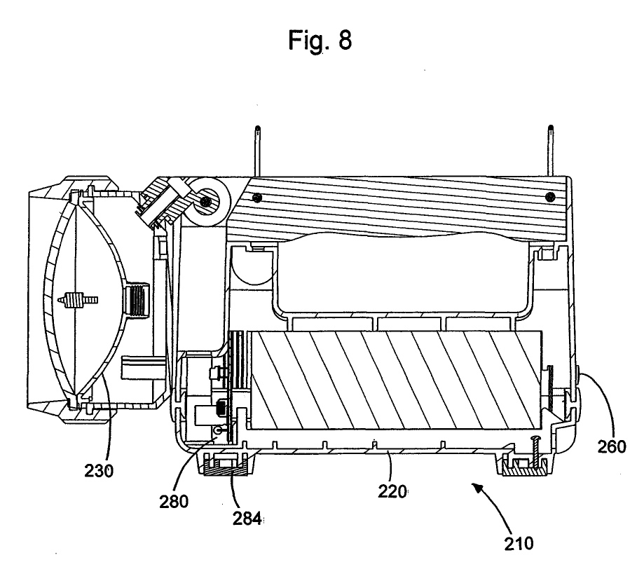

Referring now to FIGS. 7-9, a third embodiment of a flashlight 210 is illustrated. The third embodiment includes many of the features of the first flashlight 10 described above, however, this third embodiment incorporates a different mechanism for varying the functionality of the switch as described further below.

The third embodiment 210 includes a lamp assembly 230 providing a forwardly directed light source, and one or more back lights 260 providing a rearwardly directed light source. The lamp assembly 230 includes a high-powered light to provide general illumination, whereas preferably the back light provides low power light so that the person using the flashlight can be readily identified from behind when using the flashlight.

Referring now to FIG. 7, the flashlight will be described in greater detail. The flashlight 210 includes a hollow housing 220 having a generally open forward end and a generally closed rearward end. Although the housing 220 may be formed from a variety of material, including various metals and/or plastics, preferably, the housing is formed of high impact ABS.

The lamp assembly 230 is attached to the forward end of the housing 220. The lamp assembly 230 preferably includes a lens ring, a reflector, a lens and a light bulb. In the present instance, preferably the lens and the reflector are fixedly connected to one another to form a lens/reflector assembly. However, a separate lens and reflector can also be utilized with the flashlight if desired. The details and operation of the lamp assembly 230 are substantially similar to the lamp assembly 30 of the embodiment described above in connection with the first embodiment.

The housing 220 includes a compartment configured to receive a battery. As with the previous embodiments, the flashlight may use one or more batteries and the batteries may be rechargeable or non-rechargeable. Since the flashlight is preferably fluid-tight, the flashlight preferably includes a valve allowing escape of gases created by the battery during use as discussed above with the first embodiment.

The rearward end of the housing 220 is generally closed by a back wall that is substantially continuous except for one or more apertures for one or more back lights 260. In the present instance, the back lights 260 are substantially similar to the back lights discussed above in connection with the first embodiment. Specifically, the back light or back lights are configured to provide a rearward facing light source that does not project significantly from the back wall of the housing 220. In other words, the back lights are substantially enclosed within the housing so that they do not substantially protrude from the back wall.

The operation of the primary lamp 230 and the back lights 260 is controlled by a switch 250. The switch may be configured to have two or more switching positions. However, in the present instance the switch is a toggle switch having three positions, a central or off position, an up position and a down position.

Preferably, the switch 250 cooperates with a switch controller 280 that controls the operation of the primary lamp and the back lights in conjunction with the switch. The switch controller 280 is interconnected with the battery, the primary lamp 230, the back lights 260 and the switch 250.

Specifically, the switch controller 280 includes an element for controlling the electrical path between the switch 250, the lamp 230 and the back lights. In the present instance, the switch controller includes a rotary DIP switch mounted on the PCB assembly that is electrically connected with the battery, the front lamp and the back lights. The DIP switch 282 is rotatable between four different positions to vary the light output when the switch 250 is switched on.

For instance, in the primary operational position of the dip switch 282, the flashlight operates as follows. When the switch 250 is toggled into the down position, continuous power is provided to both the primary lamp 230 and the back lights 260 to provide continuous illumination by the light elements, referred to as a steady mode. When the switch is toggled to the up position the primary lamp is in the steady mode and intermittent power is provided to the back lights 260 so that the lights flash, referred to as flashing mode.

If the DIP switch 282 is rotated to a second position, when the switch 250 is toggled to the down position, the primary lamp 230 is switched on in steady mode, but the back lights are not switched on. When the switch 250 is toggled to the up position, the primary lamp 230 is off and the back lights 260 is in the flashing mode.

If the DIP switch 282 is rotated to a third position, the flashlight operates as follows. When the switch 250 is toggled into the down position, the primary lamp is on in the steady mode and the back lights 260 are off. When the switch 250 is toggled into the up position, both the primary lamp 230 and the back lights are switched on in flashing mode.

If the DIP switch 282 is rotated to a fourth position, the flashlight operates as follows. When the switch 250 is toggled into the down position, the primary lamp 230 and the back lights are both switched on in a steady mode. When the switch 250 is toggled into the up position, both the primary lamp 230 and the back lights 260 are switched on in flashing mode.

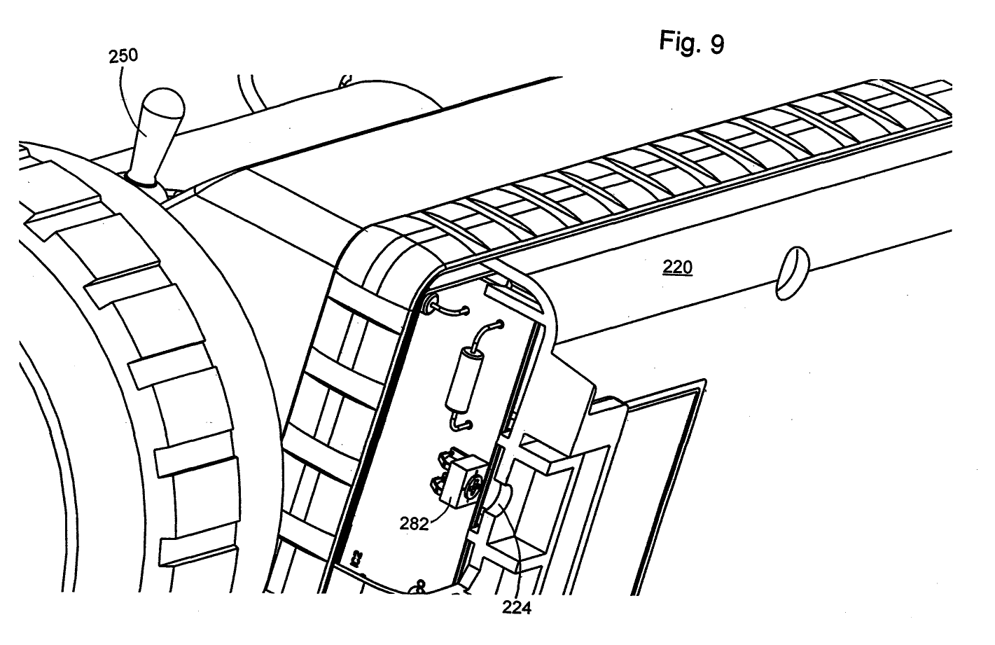

Referring to FIG. 9, the DIP switch 282 is a rotatable switch that is operable through a hole 224 in the bottom of the housing. Specifically, the DIP switch 282 has a socket or recess configured to cooperate with the tip of a tool, such as a screw driver. In the present instance, the DIP switch is configured to cooperate with a phillips screwdriver. The tip of the screw driver is inserted through the hole 224 in the housing and into the DIP switch. Rotating the screw driver then rotates the DIP switch. In the present instance, the DIP switch is configured so that the four different control positions are angularly spaced apart by approximately 90 degrees.

Since the DIP switch 282 is inside the housing, preferably a seal encloses the opening that provides access to the DIP switch. Specifically, preferably a socket is formed in the housing adjacent the opening to the DIP switch. A seal 284 is configured to sealingly engage the socket to form a fluid tight seal for the hole 224 in the housing. The seal 284 releasably engages the socket so that the seal can be removed to provide access to the DIP switch. For instance, in FIG. 9, the seal is removed so that the hole 224 can be seen.

Although the foregoing describes the preferred embodiments, various alterations can be made without departing from the broad inventive concepts of the invention. For instance, in the third embodiment of the flashlight 210, the switch controller 280 is described as a DIP switch 282 having four different position for varying the light output when the switch 250 is operated. However, the switch controller is not limited to a DIP switch. Further still, the DIP switch could have more or less positions than the four positions described above. For instance, the DIP switch may include 5 different positions with the four positions being the same as those described above and the fifth position may be used to provide an alternating mode for the back lights. Specifically, the back lights may be operable in an alternating mode in which the different back lights alternate on and off (e.g. if the back lights comprise a left light and a right light, in the alternating the mode the right and left lights blink, alternating so that when the left light is on, the right light is off, and vice versa). The switch controller may operate so that in the fifth position, when the switch is in the up position the primary lamp element is switched to a steady on mode and the back lights are off. When the switch is in the down position, the primary lamp element is switched to a steady on mode and the back lights are switched on in an alternating mode.

Numerous advantages of the present invention will be apparent to those skilled in the art from the foregoing specification. It should therefore be understood that this invention is not limited to the particular embodiments described herein, but is intended to include all changes and modifications that are within the scope and spirit of the invention as set forth in the claims.

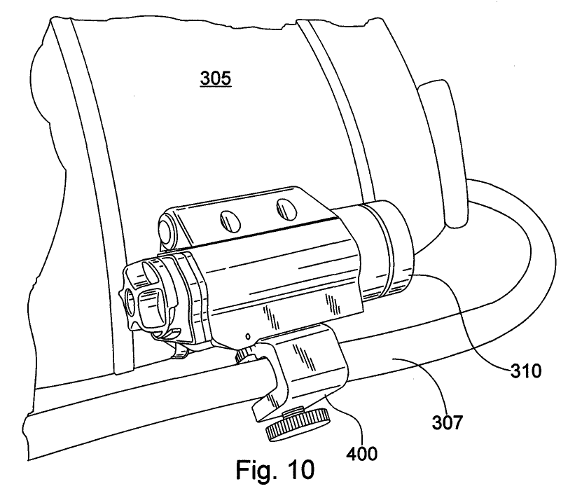

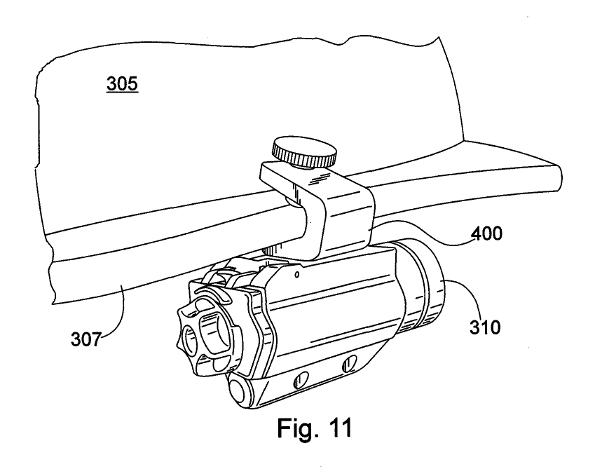

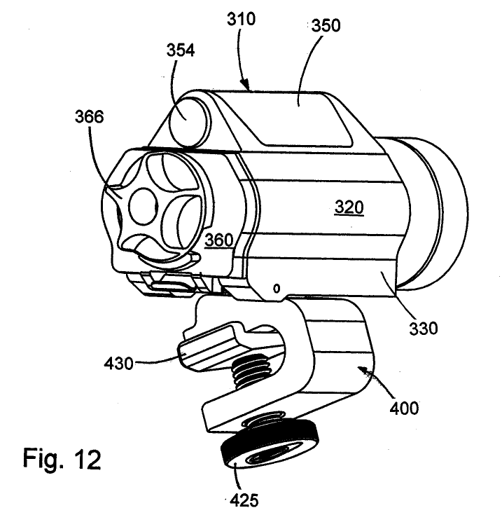

Referring now to the FIGS. 10-16b, a helmet light is designated 310. The helmet light includes a high intensity illumination light 380, as well as a rearward facing light 390. The helmet light 310 includes an integrated mount 400 for connecting the helmet light to a helmet 5. As shown in FIG. 10, the helmet light 310 may be mounted above the brim 307 of the helmet, or, as shown in FIG. 11, the helmet light may be mounted below the brim of the helmet.

The helmet light 310 includes a forward facing lamp 380 assembly having a bright light source to provide a source of illumination. The helmet light further includes a rearward facing light assembly 390. The rearward light may also provide a source of illumination, however, in the present instance, the rearward light 390 is configured to be an indicator or identification light so that the user can be readily identified from behind. Accordingly, in the present instance, the rearward light 390 is a non-white light having a lower light intensity than the forward lamp 380.

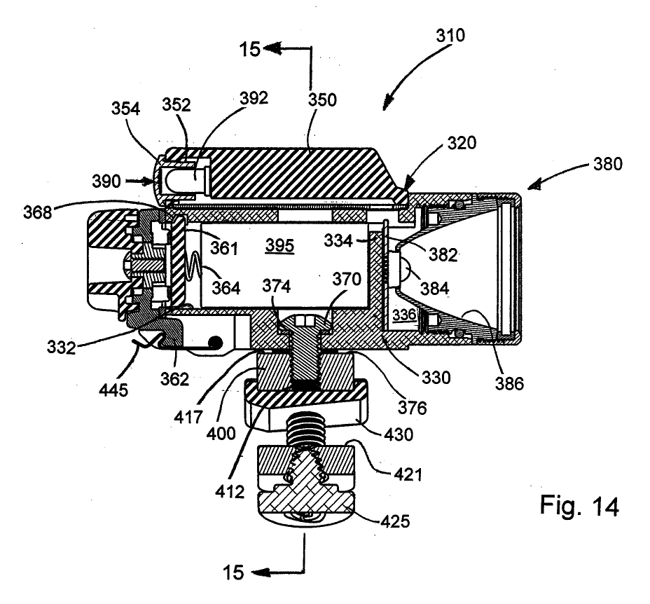

Referring now to FIG. 14, the features of the helmet light 310 will be described in greater detail. The helmet light 310 includes a housing 320 that includes a barrel 330 and an upper extension 350 housing the rearward light 390. The barrel 330 has an enlarged rearward chamber 332 forming a compartment for receiving the power source, which in the present instance is a pair of single use lithium batteries 395. Alternatively, the power supply may be rechargeable batteries if desired.

The barrel 330 includes a forward wall 334 generally enclosing the forward end of the battery compartment. Forward of the wall 334 is a chamber for housing the forward light assembly 380. A pair of contacts 335 extends through the forward wall 334 and is in circuit with the light assembly 380.

The light assembly 380 is a high intensity light source for providing an illumination light. The light assembly includes a light source, such as a xenon incandescent light bulb, and may include a reflector 386. However, in the present instance, the light source is an LED 384. Specifically, in the present instance, the light source is a high intensity LED, such as an LED providing up to 4,500 candela peak central intensity.

Referring to FIG. 14, the LED 384 is mounted on a PCB assembly 382. The PCB assembly 382 is positioned at the rearward end of the forward chamber 336, so that the PCB assembly abuts the wall 334. In the present instance, the PCB assembly 382 is shaped to conform to the interior of the housing. Additionally, in the present instance, the interior of the forward chamber 336 is non-circular, so that the mating shape of the PCB assembly and the forward chamber operate to locate the position of the LED 384 relative to the housing 320. Specifically, the LED 384 is positioned on the PCB at a predetermined position relative to the perimeter of the PCB. The configuration of the PCB perimeter mates with the interior of the chamber 336 to locate the PCB in a particular orientation relative to the housing. Since the LED is positioned on the PCB at a predetermined location, the mating of the PCB and housing therefore locate the LED at a predetermined location relative to the housing.

As mentioned above, the light assembly 380 includes a reflector 386 to focus the light from the light element 384. A shown in FIG. 14, the reflector 386 includes a threaded portion that threadedly engages an internal threaded portion of the housing. In this way, the mating threads of the reflector and the housing position the focal axis of the reflector at a predetermined location relative to the housing. Accordingly, as described above, the LED 384 is located relative to the housing and the focal axis of the reflector is located relative to the housing, so that the LED is located relative to the focal axis of the reflector.

In addition to the barrel 330, the housing 320 further includes an upper extension 350 for housing the rearward light assembly 390. The upper extension 350 may be integrally formed with the barrel 330, however, in the present instance, the upper extension 350 is a separate element rigidly connected to the top of the barrel 330. For instance, in the present instance, the upper extension is connected to the barrel with a plurality of screws.

The upper extension 350 is shaped similar to a triangular prism extending along the top of the barrel 330. The upper extension is generally hollow, and has a vertical central rib 351 connected to the apex of the upper extension and extending along a substantial portion of the length of the extension. A second PCB 394 extends along the interior of the upper extension and provides an electrical path between the rearward light 392 and the PCB 382 for the forward light assembly 380.

The forward end of the upper extension 350 is closed. The rearward end of the upper extension forms a wall having an aperture. The rearward light element 392 is mounted so that it provides illumination through the aperture 352. Specifically, light element 392 is mounted adjacent the rearward end of the upper extension. In the present instance, the rearward light element 392 is connected to the vertical rib, and abuts the rearward end of the vertical rib. The rearward end of the light is adjacent the aperture 352, and in the present instance, the light element projects into the aperture without projecting from the rearward end of the upper extension. A cover 354 encloses the rearward light within the housing 320. The cover is a plastic translucent element fixedly connected with the upper extension of the housing. In the present instance, the cover has a cylindrical body portion that projects into the aperture 352 and a flared head that abuts the rearward end of the housing extension 350. The flared head is rounded having a low profile so that the cover 352 does not significantly protrude beyond the rearward end of the housing 320.

The rearward light element 392 is an LED. In the present instance, the rearward LED is lower intensity than the forward light element 384. Additionally, the rearward light element 392 may be a different color light element than the forward light element. For instance, in the present instance, the rearward light element is a 470 nm blue LED. By providing light elements of different color, the lights make it easier to determine whether the user is facing toward or away from a person attempting to monitor or locate the user.

The rearward end of the housing 320 comprises a cover or door 60 that encloses the battery compartment 332. The door 360 includes an upper locking tab 361 that engages a slot in the upper wall of the barrel 330, as shown in FIG. 14. The door further includes a lower locking tab 362 that cooperates with a latch 345 on the housing to retain the door on the housing. Specifically, the latch 345 is pivotally connected to the housing, and has a detent that engages the lower locking tab 362 to hold the lower end of the door closed.

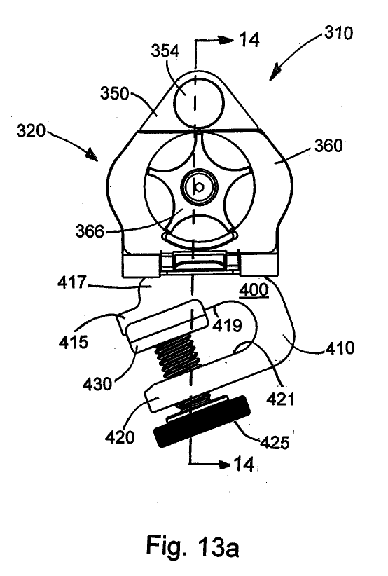

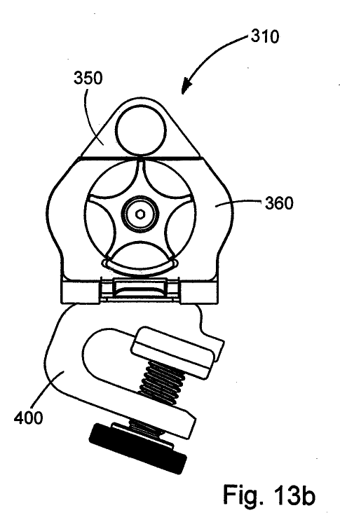

The door 360 further includes a switch 366 for controlling operation of the helmet light 310. As shown in FIG. 13a, the switch 366 comprises a rotatable star-shaped actuator. In the present instance, the switch has an actuation surface having a diameter that is approximately the same as the height of the battery compartment to provide an actuation surface that can be readily operated by emergency personnel in their safety equipment. Additionally, the actuation surface of the switch is less than the height and width of the housing. In this way, the housing impedes accidental actuation of the switch.

The switch 366 may be operable to independently control the forward light 384 and the rearward light 392. However, in the present instance, the switch 366 controls the operation of both lights together. Specifically, the door includes a pair of contacts 364 that electrically engage the batteries 395. In a first position, the switch completes the circuit between the two contacts 364, so that the forward and rearward lights are on. In a second position, the switch 366 is open to interrupt the circuit between the two contacts 364 so that the forward and rearward lights are off.

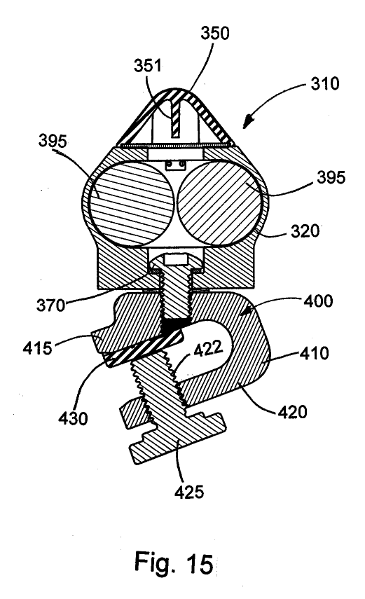

Referring now to FIGS. 14-15, the details of the integrated helmet mount 400 will be described in greater detail. The helmet mount 400 includes a u-shaped yoke 410 having an upper leg 415 and a lower leg 420. The lower leg 420 is spaced apart from the upper leg to create a gap.

The upper leg 415 includes an exterior surface that forms a base 417. In the present instance, the base 417 is a substantially flat surface disposed substantially parallel to the lower surface of the housing 320. Of course it should be appreciated, that the base may be configured in a variety of circumstances depending on the particular application.

The mount 400 includes a connection element 412 for connecting the mount to the housing 320. In the present instance, the connection element 412 is a female connector, in the form of a threaded socket. The threaded socket extends through the upper leg 415 of the yoke. However, the threaded socket may be a stopped hole that does not extend all the way through the upper leg if desired.

The upper leg 415 includes an interior surface 419 that is formed at an angle to the base surface 417, and is therefore, formed at an angle to the bottom of the housing 320. Similarly, the lower leg 420 includes an interior surface that is substantially parallel to the interior surface 419 of the upper leg.

The lower leg 420 includes a threaded hole 422 for receiving a locking element 425, which in the present instance is a thumbscrew. The threaded hole 422 is disposed at an angle to the lower leg, and in the present instance is normal to the interior surface 421 of the lower leg. The thumbscrew 425 can be threaded into the yoke 410 toward the lower leg to tighten the mount 400 onto a helmet as discussed below. Alternatively, the thumbscrew can be reversely threaded away from the lower leg to loosen the mount.

Referring to FIG. 15, the interior surface of the upper leg is a generally flat surface, and the mount 400 is connected to the housing 320 so that the plane of the interior surface is parallel with the focal axis of the forward light 380. In this way, the focal axis of the forward light is generally parallel to the brim 307 of the helmet 305 when the light is mounted onto the helmet. Although it is desirable to have such an orientation for many helmets, often is it is desirable to adjust the angle of the focal axis upwardly or downwardly from the axis of the brim 307.

To adjust the angle of the focal axis of the light 380 relative to the helmet 305, the mount 400 includes an adjustment element. The adjustment element may be an infinitely adjustable control, however, such a control can introduce an undesirable complication of the device, which could increase the cost, lower reliability or reduce the ease of use of the device. Accordingly, in the present instance, the adjustment element is an adjustment pad 430 that is configured to overlie the interior surface 419 of the upper leg 415.

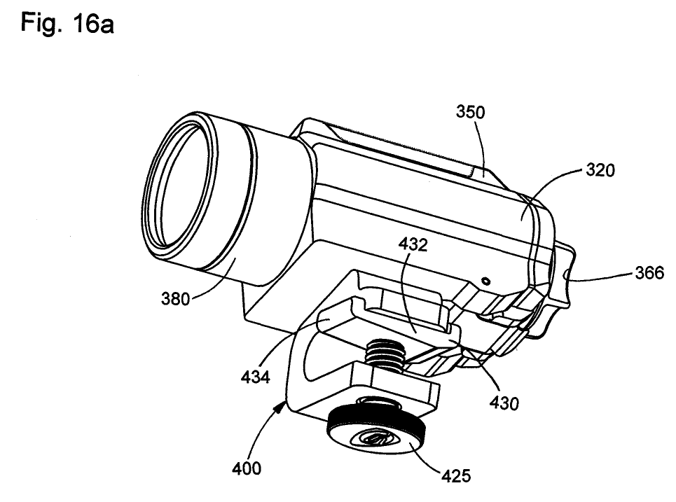

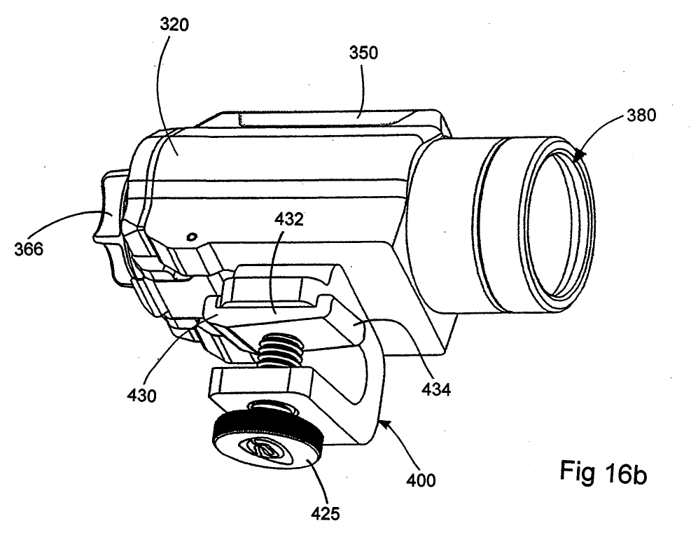

The adjustment pad 430 includes an wedge-shaped body 432 having an interior surface configured to overlie the interior surface of the upper leg 419, The outer surface of the body 432 is formed at an angle to the interior surface, thus forming the wedge-shape, as shown in FIG. 16a. The adjustment pad 430 may include features for retaining the pad on the upper leg. For example, in the present instance, the pad 430 includes a pair of retention flanges 434. The retention flanges 434 project downward from the edges of the pad and are spaced apart a distance that is approximately the same as the width of the upper leg 415, as shown in FIG. 14. In this way the retention flanges center the pad on the upper leg 415 and orient the angle of the pad along the appropriate axis.

The angle of adjustment depends on the angle of wedge-shaped body 432 and the direction that the pad 430 is mounted onto the upper leg, as mill be discussed further below. Preferably, the pad is formed to provide an angular adjustment of between 3 and 10 degrees. In the present instance, the pad provides an angular adjustment of approximately 5 degrees. Specifically, the body 432 of the pad is configured so that the outer surface of the pad forms a 5 degree angle relative to the interior surface of the upper leg. Accordingly, the outer surface of the pad forms an angle relative to the focal axis of the front light 380 of approximately 305 degrees.

Referring to FIGS. 10, 11 and 14, the adjustment that the pad 430 provides depends on the direction that the pad is mounted onto the upper leg, as well as manner in which the light is mounted onto the helmet. Specifically, as shown in FIG. 10, the light 310 is mounted in an over-the-brim orientation on the rightside of brim 307 the helmet 305. In this orientation, the adjustment pad 430 adjusts the beam of light downwardly when the pad is inserted so that the thin edge of the pad is directed forwardly, as shown in FIG. 14. Conversely, when the adjustment pad 430 is reversed so that the thin end of the wedge-shaped body is directed toward the rearward end, the wedge adjusts the beam of light upwardly (in the over-the-brim orientation on the rightside).

In the under-the-brim orientation shown in FIG. 11, the adjustment pad 430 adjusts the beam of light upwardly when the pad is inserted so that the thin end of the wedge-shaped body is directed toward the forward end of the light. Conversely, the adjustment pad adjusts the beam of light downwardly when the pad is inserted to that the thin end of the wedge-shaped body is directed toward the rearward end of the light.

As described above, there are 8 different mounting configurations using the wedge 430: (1) under-the-brim, right side, wedge forward; (2) under-the-brim, right side, wedge rearward; (3) over-the-brim, right side, wedge forward; (4) over-the-brim, right side, wedge rearward; (5) under-the-brim, left side, wedge forward; (6) under-the-brim, left side, wedge rearward; (7) over-the-brim, left side, wedge forward; and (8) over-the-brim, left side, wedge rearward. In the foregoing listing, the term “wedge forward” means that the thin end of the wedge-shaped body is directed toward the forward end of the housing, as shown in FIG. 14. The term “wedge rearward” means that the thin end of the wedge-shaped body is directed toward the rearward end of the housing.

Although there are 8 different mounting configurations using the wedge, the mount needs only 4 variations to provide the 8 mounting configurations. Specifically, the light is configured the same for both (1) under-the-brim, right side, wedge forward and (7) over-the-brim, left side, wedge forward. Similarly, the light is configured the same for the following pairs of mounting configurations:
(2) under-the-brim, right side, wedge rearward and (8) over-the-brim, left side, wedge rearward
(3) over-the-brim, right side, wedge forward and (5) under-the-brim, left side, wedge forward;
(4) over-the-brim, right side, wedge rearward and (6) under-the-brim, left side, wedge rearward.

The light has two adjustments that provide the four different light configurations, which provides the 8 different mounting configurations. The first adjustment is the pad 430. As discussed above, the pad 430 can be easily removed and reversed so that the pad either faces wedge forward or wedge rearward. Additionally, the mount 400 can be reversed relative to the housing 320 between a first and second orientation, as shown in FIGS. 13a,b and 16a,b. In the present instance, the connection between the housing 320 and the mount 400 permits reversal of the mount relative to the housing, as discussed further below.

Referring to FIG. 14, the mount 400 is fixedly connected with the housing via a connector 370. In the present instance, the connector 370 constrains motion of the mount relative to the housing to a single plane. Specifically, in the present instance, the connector 370 constrains motion of the mount to rotation about the axis of the connector.

Although a variety of connecting elements can be utilized, in the present instance, the connector is a threaded element, such as a bolt 370. The bolt threadedly engages a threaded socket 412 in the mount 100. Additionally, an adhesive bonds the bolt 70 to the threaded socket 412 to substantially permanently fix the bolt relative to the mount. In the present instance, an adhesive such as Loctite Threadlocker is used. Accordingly, the connector 370 fixes the mount to the housing to prevent relative lateral or vertical displacement of the mount relative to the housing.

Although the connector 370 constrains motion of the mount, in the present instance, the connector is connected to the mount to allow rotation of the mount relative to the housing. Specifically, the bolt 370 is threaded into the connection socket 412 such that a minor gap is created between the mount and the housing. The bolt is then fixed to the socket, such as by adhesive, to prevent the bolt from being displaced relative to the socket. By fixing the bolt relative to the socket, the gap between the mount and the socket is also substantially fixed. By creating a gap between the housing 320 and the mount 400, the mount is able to rotate relative to the housing. Specifically, the mount is able to rotate about the axis of the connector, which, in the present instance, is transverse the focal axis of the lamp 380. Additionally, although the mount is rotatable relative to the housing, the gap between the housing and the mount does not vary substantially as the mount is rotated.

The light 320 further includes one or more elements to help control the rotational displacement of the housing 320 relative to the mount 400. For instance, as shown in FIG. 14, a spacer 376, such as a washer, is disposed between the housing and the mount. The washer has a thickness that is approximately the same as the thickness of the gap between the housing and the mount to provide interference between the housing and the mount. The interference creates frictional force between the mount and the spacer 376 and the spacer and the housing 320 that controls the rotation of the mount relative to the housing. The amount of drag or friction between the housing and the mount is proportional to the amount of torque applied to the bolt 370 when threading the bolt into the mount. In the present instance, the bolt is threaded into the mount to provide sufficient frictional drag to impede rotation of the mount relative to the housing. In this way, the mount 400 is connected so that during use the housing remains substantially fixed relative to the mount to impede accidentally misaligning the light. At the same time, the connection allows the mount to be rotated when the user desires to reconfigure or reorient the light.

In the present instance, the connector 370 is positioned intermediate the ends of the housing. Specifically, the connector is positioned adjacent the midpoint of the housing. Accordingly, less than ¾ the length of the housing projects from the mount, and preferably less than ⅔ the length of the housing projects from the mount. In the present instance less than approximately ½ the length of the housing projects from the edge of the mount 400. Similarly, referring to FIG. 15, the connector is position intermediate the sides of the housing, and in the present instance is adjacent the midpoint of the width of the housing. Additionally, as can be seen in FIGS. 14-15, the locking thumbscrew 425 is adjacent the midpoint of the width and length of the housing.

As can be seen from the foregoing, the connector 370 attaches to the mount 400 to connect the mount to the housing 320. In the present instance, the connector is threaded into the mount with a predetermined torque. Additionally, a fixative, such as an adhesive fixes the connection between the mount and the connector so that the torque required to disconnect the connector from the mount is substantially greater than the predetermined torque applied to the connector 370 to connect the connector to the mount. In this way, the torque required to rotate the housing relative to the mount is substantially less than the torque required to disconnect the connector from the mount.

Configured as discussed above, the helmet light 310 provides a well-balanced light that is easy to use and easy to mount on a variety of helmets having different brims. Depending on the desired mounting orientation, the user may rotate the mount 180° relative to the housing from the first position shown in FIG. 13a to the second position shown in FIG. 13b. To mount the helmet light, the thumbscrew 425 is unscrewed to retract the thumbscrew from the mount 400. The mount 400 is then placed onto the brim 307 so that the brim is inserted into the mount between the upper and lower legs 115, 120 of the mount. Preferably, the length of the brim inserted into the mount is greater than the thickness of the brim.

After the brim is inserted into the mount 400, the thumbscrew 425 is rotated to thread the thumbscrew against the brim 307, thereby locking the light 310 onto the helmet. The mount 400 is able to accommodate a number of different brim thicknesses so that the helmet light can be mounted onto a variety of different helmets having different brims. The thumbscrew provides a lock that is infinitely adjustable so that the mount can attach to brims having a thickness range from zero thickness to an upper limit. The upper limit is thickness of the opening between the upper and lower legs 415, 420 when no adjustment pad 430 is used. If an adjustment pad is used, the upper limit for the brim thickness is reduced by the thickness of the adjustment pad.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A flashlight mountable on a helmet having a brim, wherein the flashlight comprises:
a housing configured to house a portable power source;
a first light source in a forward portion of the housing for providing an illumination light of a first color projecting from the forward end of the housing;
a second light source for providing a light of a second color projecting rearwardly from the housing;
a mount configured for releasably mounting the flashlight to the brim of a helmet, wherein the connection between the mount and the housing is substantially permanent, and wherein the connection allows the mount to rotate relative to the housing from a first position to a second position, wherein the mount comprises:
an opening slot having a thickness that is at least as thick as the approximate thickness of the helmet brim; and
a lock variable between an upper limit and a lower limit for locking onto the brim when the brim is inserted into the opening slot.

2. The flashlight of claim 1 wherein the connection between the housing and the mount provides a drag force that impedes rotation of the mount between the first and second positions.

3. The flashlight of claim 1 wherein the mount is connected to the bottom of the housing adjacent a midpoint of the housing between the front of the housing and the rear of the housing.

4. The flashlight of claim 1 wherein the first light has a focal axis and the second light is vertically spaced from the focal axis of the first light.

5. The flashlight of claim 1 wherein the lock is a threaded element that threadedly engages the mount and includes an engagement surface for engaging the brim of the helmet.

6. The flashlight of claim 1 wherein the light produced by the first light has a central axis, and the flashlight comprises an adjustment element removably connectable with the mount for adjusting the angle of the central axis relative to the brim.

7. The flashlight of claim 1 comprising a wedge removably attached with the mount for adjusting the angle of the flashlight relative to the brim.

8. The flashlight of claim 7 wherein the wedge comprises a locating element for locating the wedge on the mount within the slot.

9. The flashlight of claim 8 wherein the locating element is configured to allow the wedge to be reversed relative to the mount to alter the angle of the flashlight relative to the brim.

10. The flashlight of claim 7 wherein in a first orientation the wedge provides a first angle of adjustment of the light relative to the brim, and wherein in a second orientation the wedge provides a second angle of adjustment relative to the brim.

11. The flashlight of claim 7 wherein the wedge includes a tapered surface for providing approximately 4-6° of angular adjustment for the flashlight.

12. The flashlight of claim 1 wherein the lock is infinitely variable between the upper limit and the lower limit.

13. A flashlight mountable on a helmet having a brim, wherein the flashlight comprises:
a housing configured to house a portable power source;
a first light source in a forward portion of the housing for providing an illumination light projecting from the forward end of the housing;
a second light source projecting rearwardly from the housing;
a mount configured for releasably mounting the flashlight to the brim of a helmet, wherein the mount comprises:
an opening slot having a thickness that is at least as thick as the approximate thickness of the helmet brim;
a lock infinitely variable between an upper limit and a lower limit for locking onto the brim when the brim is inserted into the opening slot;
a connector for connecting the mount to the housing so that the mount is rotatable from a first position to a second position, wherein the mount is connected to the housing by a first torque that is sufficient to create a drag between the mount and the housing to impede rotation of the mount from the first position to the second position, and wherein a second torque opposite the first torque and substantially greater than the first torque is required to disconnect the mount from the housing, wherein application of a torque sufficient to overcome the drag causes the mount to rotate relative to the housing rather than causing the connector to rotate relative to the mount.

14. The flashlight of claim 13 wherein the mount is connected to the bottom of the housing adjacent a midpoint of the housing between the front of the housing and the rear of the housing.

15. The flashlight of claim 13 wherein the first light has a focal axis and the second light is vertically spaced from the focal axis of the first light.

16. The flashlight of claim 13 wherein the lock is a threaded element that threadedly engages the mount and includes an engagement surface for engaging the brim of the helmet.

17. The flashlight of claim 13 comprising a wedge removably attached with the mount for adjusting the angle of the flashlight relative to the brim.

18. The flashlight of claim 17 wherein the wedge comprises a locating element for locating the wedge on the mount within the slot.

19. The flashlight of claim 18 wherein the locating element is configured to allow the wedge to be reversed relative to the mount to alter the angle of the flashlight relative to the brim.

20. The flashlight of claim 17 wherein in a first orientation the wedge provides a first angle of adjustment of the light relative to the brim, and wherein in a second orientation the wedge provides a second angle of adjustment relative to the brim.

21. A flashlight mountable on a helmet having a brim, wherein the flashlight comprises:
a housing configured to house a portable power source;
a first light source in a forward portion of the housing for providing an illumination light of a first color projecting from the forward end of the housing;
a second light source for providing a light of a second color projecting rearwardly from the housing;
a mount configured for releasably mounting the flashlight to the brim of a helmet, wherein the connection between the mount and the housing is substantially permanent, and wherein the connection allows the mount to rotate relative to the housing from a first position to a second position, wherein the mount is a clamp, comprising:
a U-shaped body having an opening slot for receiving the helmet brim, wherein the opening slot comprises an upper surface and a lower surface, wherein one of the upper and lower surfaces is transverse the bottom of the housing; and
a lock variable between an upper limit and a lower limit for locking onto the brim when the brim is inserted into the opening slot.

22. The flashlight of claim 21 wherein the upper and lower surfaces of the U-shaped body are transverse the bottom of the housing.

23. The flashlight of claim 21 wherein the opening slot has a thickness and a depth, wherein the depth is greater than the thickness.

24. The flashlight of claim 21 wherein the connection between the housing and the mount provides a drag force that impedes rotation of the mount between the first and second positions.

25. The flashlight of claim 21 wherein the mount is connected to the bottom of the housing adjacent a midpoint of the housing between the front of the housing and the rear of the housing.

26. The flashlight of claim 21 wherein the lock is a threaded element that threadedly engages the mount and includes an engagement surface for engaging the brim of the helmet.

27. The flashlight of claim 21 comprising a wedge removably attached with the U-shaped body for adjusting the angle of the flashlight relative to the brim.

28. The flashlight of claim 27 wherein the wedge comprises a locating element for locating the wedge on the U-shaped body.

29. The flashlight of claim 28 wherein the locating element is configured to allow the wedge to be reversed relative to the U-shaped body to alter the angle of the flashlight relative to the brim.

30. The flashlight of claim 27 wherein in a first orientation the wedge provides a first angle of adjustment of the light relative to the brim, and wherein in a second orientation the wedge provides a second angle of adjustment relative to the brim.

31. The flashlight of claim 21 wherein the lock is infinitely variable between the upper limit and the lower limit.
